(19) United States
(12) Patent Application Publication
(10) Pub. No.: US 2013/0328773 A1
(43) Pub. Date: Dec. 12, 2013

(54) CAMERA-BASED INFORMATION INPUT METHOD AND TERMINAL

(71) Applicant: Yang Liu, Beijing (CN)

(72) Inventor: Yang Liu, Beijing (CN)

(73) Assignee: CHINA MOBILE COMMUNICATIONS CORPORATION, Beijing (CN)

(21) Appl. No.: 13/877,084

(22) PCT Filed: Sep. 28, 2011
(86) PCT No.: PCT/CN2011/080303

§ 371 Date: Aug. 28, 2013

(30) Foreign Application Priority Data
Sep. 30, 2010 (CN) 201010504122.6

(51) Int. Cl. G06F 3/03

(52) U.S. Cl. CPC G06F 3/0304
USPC 345/158

(57) ABSTRACT

Disclosed are a camera-based information input method and a terminal, for providing an input method that consumes few resources and does not block the terminal screen. The method comprises: a terminal identifying an area having specified color information from an image acquired by a camera; determining change information of the area; and determining, according to the change information, information input to the terminal.

### FIELD OF THE INVENTION

The present invention relates to the field of communication technologies and particularly to a camera-based information input method and terminal.

### BACKGROUND OF THE INVENTION

Along with constant development of terminals, functions of the terminals are increasingly powerful, and human-machine interaction approaches are also increasingly convenient, natural and friendly. To make an input, users are mostly accustomed to performing an input operation with their fingers, and the fingers are the most direct and also the most effective human-machine interaction facility In the prior art, there are the following two approaches to make an input with a finger in addition to the traditional keyboard-based finger input approach:

In the first approach, i.e., a camera-based approach, computer vision technologies are utilized to track and identify a motion locus of a finger to thereby make an input with the finger.

The existing computer vision technologies have been applied to video surveillance, license plate identification, face identification, iris identification and other fields. In recent years, gesture identification technologies based upon computer vision have also made significant progress. However the first approach has such a drawback that in order to track the motion locus of the finger, it is typically necessary to reconstruct three-dimension coordinates of the finger tip, which requires a terminal to be provided with at least two cameras for capturing the motion locus of the finger in the three-dimension space, thus imposing a high requirement on the terminal and also considerably demanding a hardware resource.

In the second approach, i.e., a touch screen-based approach, a user contacts a touch screen with his or her finger to make an input.

The second approach as a widely applied well-defined technology supports single- and multi-point touch input and is simple and convenient to use. However it still has such a drawback that a part of a display of the touch screen may be obscured by the finger in contact with the touch screen.

### SUMMARY OF THE INVENTION

Embodiments of the invention provide a camera-based information input method and terminal so as to provide an input approach with less resource consumption without obscuring a screen of the terminal.

The embodiments of the invention adopt the following technical solutions:

A camera-based information input method includes: a terminal identifying a region with specified color information in an image captured by a camera; determining change information in the region; and determining information input to the terminal from the change information.

Preferably the method further includes: before determining the information input to the terminal from the change information, the terminal determining that the amount of area change of the region over a length of time below a predetermined threshold of time is above a predetermined threshold of the amount of area change.

Preferably the method further includes: before determining operation information on the terminal from the change information, the terminal determining its input mode as a non-handwriting input mode; and determining the information input to the terminal from the change information further includes: the terminal determining whether the amount of location change of the region is above a (predetermined threshold of sliding detection from a comparison therebetween, upon determining from the change information that a trend of area change of the region is increasing and then decreasing and that both the amount of area change resulting from the increasing and the amount of area change resulting from the decreasing are above a predetermined threshold of the amount of area change, and when a comparison result is positive, determining the information input to the terminal as sliding operation information; otherwise, determining the information input to the terminal as single-clicking operation information.

Preferably the method further includes: before determining operation information on the terminal from the change information, the terminal determining its input mode as a handwriting input mode; and determining the information input to the terminal from the change information further includes: the terminal determining the information input to the terminal as motion locus information of the region, upon determining from the change information that a trend of area change of the region is increasing and then decreasing and that both the amount of area change resulting from the increasing and the amount of area change resulting from the decreasing are above a predetermined threshold of the amount of area change.

Preferably the change information in the region includes information on area change of the region or information on location change of the region or information on area change of the region and information on location change of the region.

A terminal includes: an identifying unit configured to identify a region with specified color information in an image captured by a camera; a change information determining unit configured to determine change information in the region identified by the identifying unit; and an input information determining unit configured to determine information input to the terminal from the change information determined by the change information determining unit.

Advantageous effects of the embodiments of the invention are as follows:

In the foregoing solutions according to the embodiments of the invention, it is not necessary to reconstruct three-dimension coordinates of a finger tip, but simply a region with specified color information in an image captured by a camera can be identified to thereby determine the region for an input to a terminal, so that information input to the terminal can be determined from change information in the region, and since the image is acquired by the camera in the foregoing solutions according to the embodiments of the invention, a screen of the terminal will not be obscured; and the foregoing solution can be implemented with a single camera and thus consume a less resource. Particularly the foregoing solutions identify the particular region based upon color information without involving any complex calculation for image identification and thus are particularly applicable to a mobile terminal including a CPU with a low computing capability and a low memory.

### BRIEF DESCRIPTION OF THE DRAWINGS

FIG. 1 is a schematic diagram of a specific flow of a camera-based information input method according to an embodiment of the invention;

FIG. 2 is a schematic diagram of a specific structure o a terminal according to an embodiment of the invention;

FIG. 3a is a schematic diagram of a practical application flow of the solutions according to the embodiments of the invention; and

FIG. 3b is a schematic diagram of marking an initial bounding rectangular area of a finger tip according to an embodiment of the invention.

### DETAILED DESCRIPTION OF THE EMBODIMENTS

A fundamental idea of the solutions according to the embodiments of the invention lies in that simply a region with specified color information in an image captured by a camera is identified and information input to an terminal is determined based upon change information in the region to thereby address the problems in the existing input approaches of the prior art of imposing a high requirement on the terminal, of considerably demanding a hardware resource or of obscuring a part of a display of the touch screen by the finger contacting the touch screen.

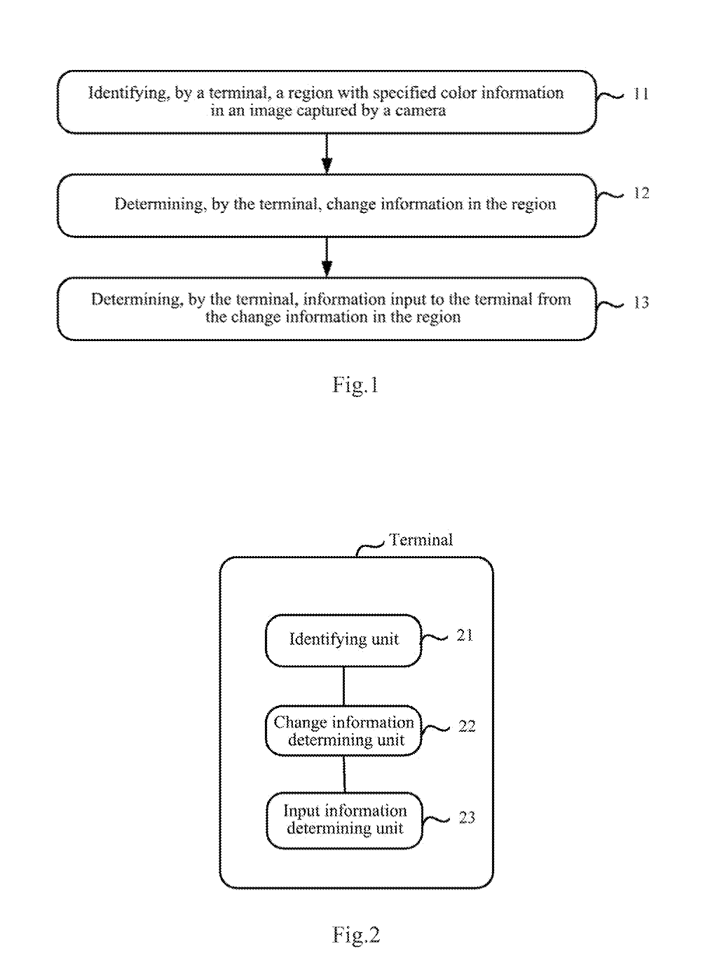

Firstly an embodiment of the invention provides a camera-based information input method, and FIG. 1 illustrates a schematic diagram of a specific flow of the method according to the embodiment of the invention, which includes the following steps.

In the step 11, a terminal identifies a region with specified color information in an image captured by a camera, where the camera can be built on the terminal or separate from the terminal, and when the camera is separate from the terminal, a connection channel will be set up between the terminal and the camera for information interaction, and moreover the region with specified color information can be a region, in the image, of a finger tip of a user, with a colored tag, captured by the camera or a region, in the image, of an input assisting facility, with a specified color, handhold by the user;

In the step 12, the terminal determines change information in the region, where the change information can be but will not be limited to information on area change of and/or information on location change of the region, and when the user makes an input with his or her finger with a colored tag, the user can perform approaching to the camera, departing from the camera, moving in front of the camera, etc., with the finger tip as desired; and

In the step 13, the terminal determines information input to the terminal from the change information in the region. In the step 13, the terminal determines a variety of information in correspondence to a variety of change information in the region, and a detailed flow will be described below, so a repeated description thereof will be omitted here.

As can be apparent from the foregoing method, in the foregoing solution according to the embodiment of the invention, instead of reconstructing three-dimension coordinates of a finger tip, simply the region with specified color information in the image captured by the camera is identified to be determined in the image, and the information input to the terminal is determined from the change information in the region, so that in the solution according to the embodiment of the invention, no more than one camera is required to reconstruct three-dimension coordinates, and there is a less demand for a hardware resource. Moreover since in the foregoing solution according to the embodiment of the invention, the image is captured by the camera, and the user will not contact the terminal (including a screen), so the screen of the terminal will not be obscured. Particularly since the particular region is identified in the foregoing solution based upon the color information without involving any complex calculation for image identification, this is particularly applicable to a mobile terminal including a CPU with a low computing capability and a low memory.

In order to avoid a mis-operation due to a dithering finger of the user, in an embodiment of the invention, before the information input to the terminal is determined from the change information in the region, there can be further included a step in which the terminal determines that the amount of area change of the identified region over a length of time below a predetermined threshold of time is above a predetermined threshold of the amount of area change. With this step, even if the dithering finger of the user makes the amount of area change of the region above the predetermined threshold of the amount of area change, since the area change of the region thus occurs over a length of time below the predetermined threshold of time, it can be determined at this time that the user just has his or her finger slightly dithering instead of intending to make an input of specific signaling with the finger.

In the embodiment of the invention, in the flow illustrated in FIG. 1, before the information input to the terminal is determined from the change information in the region, there can be further included a step in which the terminal determines its input mode, where the input mode here can be preset, and the input mode can include a non-handwriting input mode, a handwriting input mode, etc.

Upon determining that the terminal is in a non-handwriting input mode, the terminal can determine the information input to the terminal from the change information in the region particularly as follows:

Firstly the terminal determines whether the amount of location change of the region is above, a predetermined threshold of sliding detection from a comparison therebetween, upon determining from the change information in the region that a trend of area change of the region is increasing and then decreasing and that both the amount of area change resulting from the increasing and the amount of area change resulting from the decreasing are above the predetermined threshold of the amount of area change;

Then when a comparison result is positive, the information input to the terminal is determined as sliding operation information; otherwise, the information input to the terminal determined as single-clicking operation information.

Upon determining that the terminal is in a handwriting input mode, the terminal can determine the information input to the terminal from the change information in the region particularly as follows:

The terminal determines the information input to the terminal as motion locus information of the region, upon determining from the change information in the region that a trend of area change of the region is increasing and then decreasing and that both the amount of area change resulting from the increasing and the amount of area change resulting from the decreasing are above the predetermined threshold of the amount of area change.

As already mentioned above, in the embodiment of the invention, the change information in the identified region can be information on area change of or information on location change of or information on area change of and information on location change of the region. The foregoing description relates to the information input to the terminal being determined from the information on area change and from “the information on area change of and the information or location change”. For the information input to the terminal being determined from the information on location change, in a particular embodiment, upon determining that the terminal is in a handwriting input mode, the terminal determines the information input to the terminal from the change information in the region particularly as follows: the terminal can determine the information input to the terminal as motion locus information of the region, upon determining from the information on location change of the region that the amount of location change of the region is above a predetermined threshold of the amount of location change.

In the foregoing method according to the embodiment of the invention, the terminal can be a mobile terminal, e.g., a mobile phone, or a non-mobile terminal, e.g., a PC, etc.

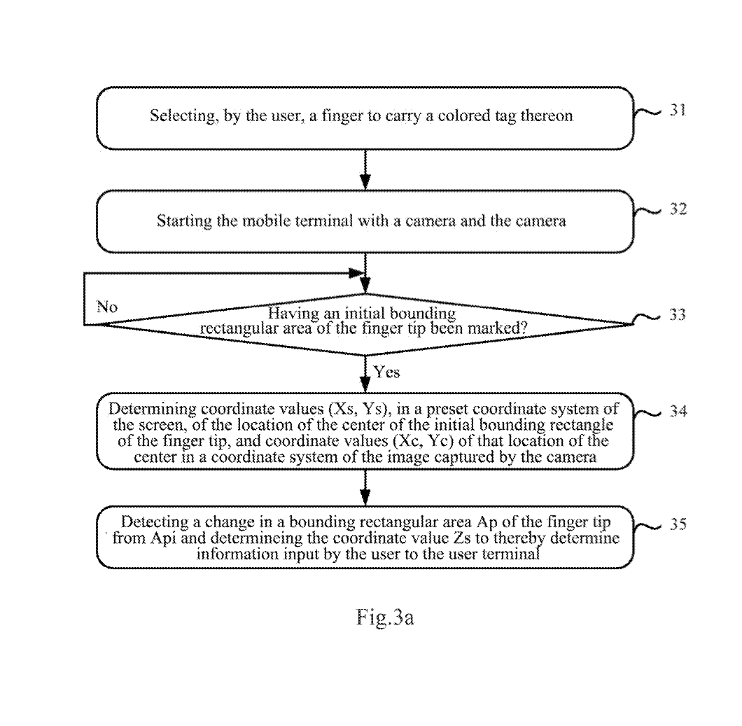

In correspondence to the foregoing input method according to the embodiment of the invention, an embodiment of the invention further includes a terminal to address the problems in the existing input approaches of the prior art of imposing a high requirement on the terminal, of considerably demanding a hardware resource or of obscuring a part of a display of the touch screen by the finger contacting the touch screen. FIG. 2 illustrates a schematic diagram of a specific structure of the terminal including the following functional units:

An identifying unit 21 configured to identify a region with specified color information in an image captured by a camera, where the region with specified color information can be a region, in the image, of a finger tip of a user with a colored tag;

A change information determining unit 22 configured to determine change information in the region identified by the identifying unit 21, where the change information can be information on area change of the region or information on location change of the region or information on area change of the region and information on location change of the region; and

An input information determining unit 23 configured to determine information input to the terminal from the change information determined by the change information determining unit 22.

In order to avoid a mis-operation due to a dithering finger of the user, the terminal can further include a change amount determining unit configured to determine that the amount of area change of the region identified by the identifying unit 21 over a length of time below a predetermined threshold of time is above a predetermined threshold of the amount of area change before the input information determining unit 23 determines the information input to the terminal.

Preferably the terminal according to an embodiment of the invention can further include a mode determining unit configured to determine an input mode of the terminal as a non-handwriting input mode before the input information determining unit 23 determines the information input to the terminal, so that upon determining the input mode of the terminal as the non-handwriting input mode, the input information determining unit 23 can include: a comparing module configured to determine whether the amount of location change of the region is above a predetermined threshold of sliding detection from a comparison therebetween, upon determining from the change information in the region that a trend of area change of the region is increasing and then decreasing and that both the amount of area change resulting from the increasing and the amount of area change resulting from the decreasing are above the predetermined threshold of the amount of area change; and an information determining module configured to determine the information input to the terminal as sliding operation information when a comparison result of the comparing module is positive; otherwise, determine the information input to the terminal as single-clicking operation information.

Alternatively when the terminal according to an embodiment of the invention includes a mode determining unit configured to determine an input mode of the terminal as a handwriting input mode before the input information determining unit 23 determines the information input to the terminal, the input information determining unit 23 can be further configured to determine the information input to the terminal as motion locus information of the region, upon determining from the change information in the region that a trend of area change of the region is increasing and then decreasing and that both the amount of area change resulting from the increasing and the amount of area change resulting from the decreasing are above the predetermined threshold of the amount of area change.

A specific practical application process of the foregoing solution according to an embodiment of the invention will be described below in details taking a specific application flow of the solution as an example.

Taking an application of the solution to a mobile terminal as an example, in order to accommodate the characteristics of the mobile terminal including a CPU with a low operating capability and a low memory, in an embodiment of the invention, a user can have a colored tag carried on his or her tip of a finger (or the tip of an item similar to the finger) so that computer vision-based identification of a motion locus of the finger can be simplified to thereby translate the complex problem of finger identification into a simple problem of color identification and thus improve an operating efficiency of the solution according to the embodiment of the invention. In a practical application, the user can manage to select, considering the color of a scene where the mobile terminal is located, a colored tag sharply different in color from the scene so that the mobile terminal can identify rapidly the finger of the user. Generally the colored tag is regular in shape, for example, it can be in a rectangular, an ellipse, a round or other shapes.

After a camera captures an image including the colored tag, the image can be taken as an initial image and the center of a screen of the mobile terminal can be taken as a base point to thereby mark a bounding rectangular area, in the initial image, of the finger tip with the colored tag. Secondly Xs and Ys axes coordinate values of coordinates on the screen can be calculated by identifying a region where the colored tag of the finger tip is located. Then the Zs axis of the coordinates on the screen can be emulated by detecting a change in the bounding rectangular area of the finger tip. For example, the terminal can start recording a motion locus of the finger tip upon detecting a larger bounding rectangular area of the finger tip in an image captured by the camera than the bounding rectangular area of the finger tip in the initial image; and will not record any motion locus of the finger tip upon detecting a smaller bounding rectangular area of the finger tip in an image captured by the camera than the bounding rectangular area of the finger tip in the initial image. The three-dimension coordinates (Xs, Ys, Zs) of motion of the finger tip can be derived by recording the motion locus of the finger tip, where the Zs axis corresponds to a change in the bounding rectangular area of the finger tip and is a binary coordinate axis. Specifically Zs is 0 when the bounding rectangular area of the finger tip in the image is larger than the bounding rectangular area of the finger tip in the initial image, and Zs is 1 when the bounding rectangular area of the finger tip in the image is smaller than the bounding rectangular area of the finger tip in the initial image.

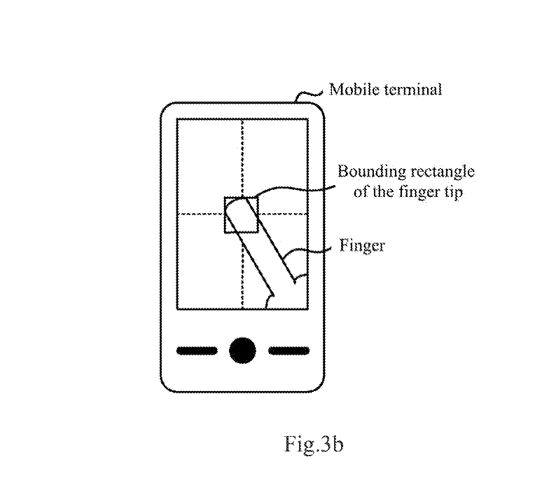

FIG. 3a illustrates a schematic diagram of a specific flow of performing the foregoing process, which includes the following steps:

In the step 31, the user selects one of his or her fingers to carry a colored tag thereon, where the user can select a finger to carry a colored tag thereon as lie or she is accustomed, for example, the index finger of the right hand to carry a red tag thereon.

In the step 32, the mobile terminal with a camera and the camera are started. Some mobile terminals are provided with two cameras (one on the front of the mobile terminal and the other on the back face of the mobile terminal), and one of the cameras can be selected for use as preset by the user. When the camera on the front of the mobile terminal is started, the finger operates in front of the mobile terminal; and when the camera on the back of the mobile terminal is started, the finger operates behind the mobile terminal.

In the step 33, the mobile terminal marks a bounding rectangular area of the finger tip in an initial image (which will be simply referred below to as an initial bounding rectangular area of the finger tip) and determines whether the marking has been done, and the flow proceeds to the step 34 upon positive determination; otherwise, the flow proceeds to the step 33. FIG. 3b; is a schematic diagram of marking an initial bounding rectangular area of a finger tip. As illustrated in FIG. 3b, the initial bounding rectangular area of the finger tip is marked with the center of the screen of the mobile terminal being as a base point. The marking operation can be performed only when it is the first time for the user to make an input with the solution according to the embodiment of the invention instead of each time of making an input. Specifically the step 33 can be performed in the following several sub-steps:

Firstly the mobile terminal displays the image captured by the camera onto the screen;

Then the user moves the finger to have the finger tip with the colored tap moved into a square box (the size of which can be set) at the center of the screen as illustrated FIG. 3b; and

Finally the terminal identifies the color of the colored tag carried by the finger tip in the image and determines a region where the color is located and records a bounding rectangular area of the region, i.e., an initial bounding rectangular area Api of the finger tip, when the region resides in the square box for a period of time above a preset value (e.g., 2 seconds).

In the step 34, coordinate values (Xs, Ys), in a preset coordinate system of the screen, of the location of the center of the initial bounding rectangle of the finger tip is determined, and coordinate values (Xc, Yc) of that location of the center in a coordinate system of the image captured by the camera is determined. It shall be noted that (Xs, Ys) will be determined using a linear transform relationship as indicated in Equ. 1 below between the coordinate system of the screen and the coordinate system of the image acquired by the camera:

Xs=Sw*Xc/Cw

Ys=Sb*Yc/Ch [1]

Particularly Xs/Ys represent coordinate values on the horizontal/vertical axes of the coordinate system of the screen of the mobile terminal, where the coordinate origin of the coordinate system can be the point at the topmost left corner of the screen of the mobile terminal; Sw/Sh represent the width/height of the screen of the mobile terminal; Xe/Yc represent coordinate values on the horizontal/vertical axes of the coordinate system of the image acquired by the camera, where the coordinate origin of the coordinate system can be the point at the topmost left corner of the image acquired by the camera; and Cw/Ch represent the width/height of the image acquired by the camera, where all the parameters are represented in units of pixels.

In the step 35, the mobile terminal detects a change in a bounding rectangular area Ap of the finger tip from the initial bounding rectangular area Api of the finger tip and determines the coordinate value Zs, on the third dimension, of the location of the center of the bounding rectangle of the finger tip to thereby determine information input by the user to the user terminal.

There can be several scenario of the step 35, in one of which, when the mobile terminal determines Ap>Api, a contact event (simply referred to as a T event below) is triggered, and at this time, the coordinate value, on the Zs axis, of the location of the center is determined as 0 indicating that the finger of the user is approaching to the camera, which is equivalent to the user contacting the touch screen with the finger; and when the mobile terminal determines Ap<Api, a non-contact event (simply referred to as a U event below) is triggered, and at this time, the coordinate value, on the Zs axis, of the location of the center is determined as 1 indicating that the finger of the user is departing from the camera, which is equivalent to the user not contacting the touch screen with the finger.

It shall be noted that in an embodiment of the invention, some dithering can be identified and filtered by detecting the movement distance and the movement speed of the finger to thereby improve smoothness of an input of the finger and mitigating an influence of a mis-operation arising from the dithering finger. Since dithering is generally characterized by a short duration of time of occurring dithering and a small amount of area change resulting from dithering, when a T event or a U event is triggered, the event can be attributed to the dithering finger of the user if Equ. 2 below holds true, thus ignoring an operation corresponding to the event.

|Ap1−Ap2|×|P1t−P2t|<Td [2]

Particularly Ap2 and Ap1 represent the bounding rectangle areas of the finger tip before and after movement thereof respectively, P1t and P2t represent temporal values when images corresponding to Ap1 and Ap2 are captured by the camera respectively, and Td represents a predetermined threshold of dithering. The foregoing formula physically means that when the finger of the user satisfies both of the conditions of a small movement distance and a high movement speed, just the dithering finger of the user can be identified instead of intentional movement, so that the movement process can be ignored to thereby avoid some mis-operation.

In the step 35, single-finger input operations similar to an input on touch screen, e.g., clicking, sliding, handwriting input, etc., can be further determined by detecting a change in the coordinates (Xs, Ys, Zs) of the location of the center of the bounding rectangular of the finger tip.

To facilitate the process, in an embodiment of the invention, finger input operations can be categorized in two modes, i.e., a non-handwriting input mode and a handwriting input mode. Clicking and upward, downward, leftward and rightward sliding belong to the non-handwriting input mode, and handwriting input belongs to the handwriting input mode.

Specifically the operations of clicking, upward, downward, leftward and rightward sliding, handwriting input, etc., are identified particularly as follows:

1. Clicking Operation

A clicking operation is identified particularly as follows:

Coordinate values P1 (Xs, Ys), on the screen of the mobile terminal, of the location of the center of the bounding rectangle of the finger tip are recorded upon detection of a T event;

Coordinate values P2 (Xs, Ys), on the screen of the mobile terminal, of the location of the center of the bounding rectangle of the finger tip are recorded upon detection of a U event; and

An input operation to the user terminal is identified as a clicking operation when two conditions as indicted in Equ.3 below are satisfied:

|P2(Xₛ)−P1(Xₛ)|<Tc

|P2(Yₛ)−P1(Yₛ)|<Tc [3]

Where Tc is a predetermined threshold of anti-dithering for handling a dithering condition of the clicking operation, and it is not appropriate to set this threshold too large, which can be set, for example, to 10.

2. Upward, Downward, Leftward and Rightward Sliding Operations

Upward, downward, leftward and rightward sliding operations are identified particularly as follows:

Coordinate values P1 (Xs, Ys), on the screen of the mobile terminal, of the location of the center of the bounding rectangle of the finger tip are recorded upon detection of a T event;

Coordinate values P2 (Xs, Ys), on the screen of the mobile terminal, of the location of the center of the bounding rectangle of the finger tip are recorded upon detection of a U event; and

An input operation to the user terminal is identified as a leftward operation when Equ. 4 below is satisfied:

|P2(Xₛ)−P1(Xₛ)|<−Tm

|P2(Xₛ)−P1(Xₛ)|>|P2(Yₛ)−P1(Yₛ)| [4]

An input operation to the user terminal is identified as a rightward operation when Equ. 5 below is satisfied:

|P2(Xₛ)−P1(Xₛ)|>Tm

|P2(Xₛ)−P1(Xₛ)|>|P2(Yₛ)−P1(Yₛ)| [5]

An input operation to the user terminal is identified as an upward operation when Equ. 6 below is satisfied:

|P2(Yₛ)−P1(Yₛ)|<−Tm

|P2(Yₛ)−P1(Yₛ)|>|P2(Xₛ)−P1(Xₛ)| [6]

An input operation to the user terminal is identified as a downward operation when Equ. 7 below is satisfied:

|P2(Yₛ)−P1(Yₛ)|>Tm

|P2(Yₛ)−P1(Yₛ)|>|P2(Xₛ)−P1(Xₛ)| [7]

Where Tm is a predetermined threshold of sliding detection, and the upward, downward, leftward and rightward sliding operations will be triggered only if a sliding distance is above this threshold, and it is not appropriate to set the threshold too large or too small, which can be set, for example, to 30.

3. Handwriting Input Operation

A handwriting input operation is identified particularly as follows:

Coordinate values of respective moved-to locations, on the screen of the mobile terminal, of the location of the center of the bounding rectangle of the finger tip are recorded, starting upon detection of a T event, as a sequence of coordinates Sp; and

Recording the sequence of coordinates Sp is terminated upon detection of a U event, and the recorded sequence of coordinates Sp is passed to a handwriting input application of the mobile terminal to perform a corresponding handwriting input operation.

With the solutions according to the embodiments of the invention, the user can perform conveniently with a single finger the finger input operations of clicking, upward, downward, leftward and rightward sliding, handwriting input, etc. As compared with a finger input based upon a touch screen, no content of the screen will be Obscured by a finger input based upon the camera of the mobile terminal to thereby enable more natural interaction instead of the traditional finger input approaches based upon a touch screen. Existing mobile terminals perform an input operation typically with a keyboard, a touch screen, voice, etc., and with the foregoing solutions according to the embodiments of the invention, the mobile terminals can be further provided with a novel finger input approach based upon cameras of the mobile terminals to thereby enable more natural and intuitive gesture interaction operations.

Evidently those skilled in the art can make various modifications and variations to the invention without departing from the spirit and scope of the invention. Accordingly the invention is also intended to encompass these modifications and variations thereto as long as the modifications and variations come into the scope of the claims appended to the invention and their equivalents.

1. A camera-based information input method, comprising:
identifying, by a terminal, a region with specified color information in an image captured by a camera;
determining change information in the region; and
determining, from the change information, information input to the terminal.

2. The method according to claim 1, further comprising:
before determining, from the change information, information input to the terminal, determining, by the terminal, that an amount of area change of the region over a length of time below a predetermined threshold of time is above a predetermined threshold of the amount of area change.

3. The method according to claim 1, further comprising: before determining the information input to the terminal from the change information,
determining, by the terminal, its input mode as a non-handwriting input mode; and
determining, from the change information, information input to the terminal further comprises:
determining, by the terminal, whether an amount of location change of the region is above a predetermined threshold of sliding detection, from a comparison therebetween, upon determining from the change information that a trend of area change of the region is increasing and then decreasing and that both an amount of area change resulting from the increasing and the amount of area change resulting from the decreasing are above a predetermined threshold of the amount of area change, and
if the amount of location change of the region is above the predetermined threshold of sliding detection, determining the information input to the terminal as sliding operation information; otherwise, determining the information input to the terminal as single-clicking operation information.

4. The method according to claim 1, further comprising: before determining the information input to the terminal from the change information,
determining, by the terminal, its input mode as a handwriting input mode; and
determining, from the change information, information input to the terminal further comprises:
determining, by the terminal, the information input to the terminal as motion locus information of the region, upon determining from the change information that a trend of area change of the region is increasing and then decreasing and that both an amount of area change resulting from the increasing and the amount of area change resulting from the decreasing are above a predetermined threshold of the amount of area change.

5. The method according to claim 1, further comprising: before determining t the information input to the terminal from the change information,
determining, by the terminal, its input mode as a handwriting input mode; and
determining, from the change information, information input to the terminal further comprises:
determining, by the terminal, the information input to the terminal as motion locus information of the region, upon determining from the change information that an amount of location change of the region is above a predetermined threshold of the amount of location change.

6. A terminal, comprising:
an identifying unit configured to identify a region with specified color information in an image captured by a camera;
a change information determining unit configured to determine change information in the region identified by the identifying unit; and
an input information determining unit configured to determine, from the change information determined by the change information determining unit, information input to the terminal.

7. The terminal according to claim 6, further comprising:
a change amount determining unit configured to determine, before the input information determining unit determines the information input to the terminal, that an amount of area change of the region identified by the identifying unit over a length of time below a predetermined threshold of time is above a predetermined threshold of the amount of area change.

8. The terminal according to claim 6, further comprising:
a mode determining unit configured to determine, before the input information determining unit determines the information input to the terminal, an input mode of the terminal as a non-handwriting input mode; and
the input information determining unit further comprises:
a comparing module configured to determine whether an amount of location change of the region is above a predetermined threshold of sliding detection, from a comparison therebetween, upon determining from the change information that a trend of area change of the region is increasing and then decreasing and that both an amount of area change resulting from the increasing and the amount of area change resulting from the decreasing are above a predetermined threshold of the amount of area change, and
an information determining module configured to determine, if the comparing module determines that the amount of location change of the region is above the predetermined threshold of sliding detection, the information input to the terminal as sliding operation information; otherwise, determine the information input to the terminal as single-clicking operation information.

9. The terminal according to claim 6, further comprising:
a mode determining unit configured to determine, before the input information determining unit determines the information input to the terminal, an input mode of the terminal as a handwriting input mode; and
the input information determining unit is further configured to determine the information input to the terminal as motion locus information of the region, upon determining from the change information that a trend of area change of the region is increasing and then decreasing and that both an amount of area change resulting from the increasing and the amount of area change resulting from the decreasing are above a predetermined threshold of the amount of area change.

10. The terminal according to claim 6, further comprising:
a mode determining unit configured to determine, before the input information determining unit determines the information input to the terminal, an input mode of the terminal as a handwriting input mode; and
the input information determining unit is further configured to determine the information input to the terminal as motion locus information of the region, upon determining from the change information that an amount of location change of the region is above a predetermined threshold of the amount of location change.
